(19) United States
(12) Patent Application Publication
(10) Pub. No.: US 2026/0227868 A1
(43) Pub. Date: Aug. 6, 2026

(54) MOUSE AND MAGNETIC ROLLER MODULE THEREOF

(71) Applicant: Voyetra Turtle Beach, Inc., San Diego, CA (US)

(72) Inventors: Wei Chuan WANG, New Taipei City (TW); Thaddaeus Erasmus Georg Richard TETZNER, Hamburg (DE); Ying Chieh HUNG, New Taipei City (TW); Chih Wei HUNG, New Taipei City (TW)

(73) Assignee: Voyetra Turtle Beach, Inc., San Diego, CA (US)

(21) Appl. No.: 19/152,662

(22) PCT Filed: Feb. 5, 2024
(86) PCT No.: PCT/US2024/014385

§ 371 Date: Jul. 31, 2025

(30) Foreign Application Priority Data
Feb. 3, 2023 (TW) 112103922
Feb. 3, 2023 (TW) 112200995
Mar. 1, 2023 (CN) 202310183850.9
Mar. 1, 2023 (CN) 202320351783.2

(51) Int. Cl. G06F 3/0362; G06F 3/0354; H01F 7/02

(52) U.S. Cl. CPC G06F 3/0362; G06F 3/0354; H01F 7/02

(57) ABSTRACT

A mouse may include: a housing and a magnetic attraction type scroll wheel module disposed inside the housing. The magnetic attraction type scroll wheel module may include a frame body, an immobile inner wheel statically mounted on the frame body and including a rotating shaft and an immobile piece, a rotating outer wheel and a magnetic object. The immobile piece may be formed with outward-facing external teeth arranged in a circle; the rotating outer wheel may be rotatably sleeved on the rotating shaft and include a rotating piece formed with inward-facing internal teeth arranged in a circle, wherein the internal teeth and the external teeth correspond to each other in an offset manner. The magnetic object may connected to the immobile piece (or the rotating piece), and the external teeth magnetically attract the internal teeth (or vice versa).

### CROSS-REFERENCE TO RELATED APPLICATIONS

This application claims the benefit of Taiwan Patent Application No. 112103922, filed Feb. 3, 2023, Taiwan Patent Application No. 112200995, filed Feb. 3, 2023 (which issued as Taiwan Patent No. M643712 on July 11, 2023), Chinese Patent Application No. 202310183850.9, filed Mar. 1, 2023, and Chinese Patent Application No. 202320351783.2, filed Mar. 1, 2023 (which issued as Chinese Patent No. ZL 202320351783.2 on October 27, 2023), which are hereby incorporated herein by reference in their entirety.

### TECHNICAL FIELD

The present application relates to a scroll wheel of a mouse, in particular to a mouse and a magnetic attraction type scroll wheel module thereof.

### BACKGROUND

A mouse includes a housing and a scroll wheel module arranged inside the housing, and a user can control a scrollbar thumb, displayed on a screen, to scroll upwards and downwards or to the left and right by rolling or tilting a scroll wheel of the scroll wheel module.

In order to enable the user to achieve detent scrolling when rolling the wheel, a magnet-type detent scrolling structure is additionally provided inside the mouse at present.

However, with regard to the existing magnet-type detent scrolling structure, a magnet and a member to be magnetically attracted are separated by an object, for example, a rubber ring sleeved on the wheel. In other words, the member to be magnetically attracted is indirectly magnetically attracted to the magnet, resulting in weakening of the magnetic attraction effect between the magnet and the member to be magnetically attracted, and thus the detent scrolling felt by the user when rolling the wheel is affected, which has been a known issue for a long time.

Thus, how to overcome the defects in the prior art is a major issue to be solved by the creator of the present application.

### SUMMARY OF THE INVENTION

The present application aims to provide a mouse and a magnetic attraction type scroll wheel module thereof, which can achieve an improved effect of detent scrolling by means of the direct magnetic attraction effect during rolling.

In order to achieve the above-mentioned purpose, the present application provides a magnetic attraction type scroll wheel module, comprising: a frame body; an immobile inner wheel statically mounted on the frame body and provided with a rotating shaft, wherein the immobile inner wheel is provided with an immobile piece, and the immobile piece is formed with external teeth projecting outwards and arranged in a circle; a rotating outer wheel rotatably sleeved on the rotating shaft and provided with a rotating piece, wherein the rotating piece is formed with internal teeth projecting inwards and arranged in a circle, and the internal teeth and the external teeth correspond to each other in an offset manner; and a magnetic object connected to the immobile piece for magnetic conduction, wherein the external teeth of the immobile piece magnetically attract the internal teeth of the rotating piece.

Optionally, the immobile inner wheel is provided with a cavity, and the magnetic object is accommodated inside the cavity.

Optionally, the immobile inner wheel is formed with lateral teeth projecting from a lateral side thereof, and the external teeth mesh with the lateral teeth.

Optionally, the immobile inner wheel is further provided with a clamping block, and the immobile inner wheel is statically mounted on the frame body by means of the rotating shaft and the clamping block together.

Optionally, the frame body is provided with a clamping recess, and the clamping block of the immobile inner wheel is clamped inside the clamping recess.

Optionally, the rotating outer wheel is provided with an accommodating chamber and a shaft hole in corresponding communication with the accommodating chamber, the immobile inner wheel is accommodated inside the accommodating chamber, and one end of the rotating shaft passes through the shaft hole and is inserted in the frame body.

Optionally, the rotating piece is located inside the accommodating chamber and is fixed to the rotating outer wheel.

Optionally, the magnetic object is a permanent magnet or an electromagnet.

Optionally, the rotating outer wheel is further surrounded by a rubber ring.

The present application further provides another magnetic attraction type scroll wheel module, comprising: a frame body; an immobile inner wheel statically mounted on the frame body and provided with a rotating shaft, wherein the immobile inner wheel is provided with an immobile piece, and the immobile piece is formed with external teeth projecting outwards and arranged in a circle; a rotating outer wheel rotatably sleeved on the rotating shaft and provided with a rotating piece, wherein the rotating piece is formed with internal teeth projecting inwards and arranged in a circle, and the internal teeth and the external teeth correspond to each other in an offset manner; and a magnetic object connected to the rotating piece for magnetic conduction, wherein the internal teeth of the rotating piece magnetically attract the external teeth of the immobile piece.

The present application also provides a mouse, comprising: a housing provided with an accommodating space; and the above-mentioned magnetic attraction type scroll wheel module, wherein the magnetic attraction type scroll wheel module is accommodated inside the accommodating space, the frame body is fixed to the housing, and the rotating outer wheel is partially exposed out of the housing.

Compared with the prior art, the present application has the following effects: by means of the special structure configuration, the internal teeth of the rotating outer wheel and the external teeth of the immobile inner wheel correspond to each other in an offset manner and are not separated by any object, and the immobile piece or the rotating piece is subjected to magnetic conduction by means of the magnetic object, so that the internal teeth of the rotating piece will be directly magnetically attracted to the external teeth of the immobile piece, thereby achieving an improved effect of detent scrolling.

### BRIEF DESCRIPTION OF THE DRAWINGS

FIG. 1 is an exploded perspective view of an immobile inner wheel in a first embodiment of a scroll wheel module of the present application.

FIG. 2 is an exploded perspective view between the immobile inner wheel and a rotating outer wheel in the first embodiment of the scroll wheel module of the present application.

FIG. 3 is an assembled perspective view of the present application according to FIG. 2.

FIG. 4 is an exploded perspective view of the first embodiment of the scroll wheel module of the present application at a viewing angle.

FIG. 5 is an exploded perspective view of the first embodiment of the scroll wheel module of the present application at another viewing angle.

FIG. 6 is a cross-sectional view of the first embodiment of the scroll wheel module of the present application at a viewing angle when assembled.

FIG. 7 is a cross-sectional view of the first embodiment of the scroll wheel module of the present application at another viewing angle when assembled.

FIG. 8 is a side view of a mouse of the present application.

FIG. 9 is a cross-sectional view of a second embodiment of the scroll wheel module of the present application at a viewing angle.

In the drawings:
100: scroll wheel module; 1: frame body; 11: recess; 12: clamping recess; 2: immobile inner wheel; 21: rotating shaft; 22: clamping block; 23: lateral teeth; 24: cavity; 25: immobile piece; 251: external teeth; 3: rotating outer wheel; 3a: wheel body; 3b: rubber ring; 31: shaft hole; 32: accommodating chamber; 33: rotating piece; 331: internal teeth; 4: magnetic object; 900: housing; and S: accommodating space.

### DETAILED DESCRIPTION OF THE PREFERRED EMBODIMENTS

The present invention is further illustrated in combination with drawings and preferred embodiments below, so that a person skilled in the art would have been able to better understand and implement the present invention. However, the given embodiments are not intended to limit the present invention.

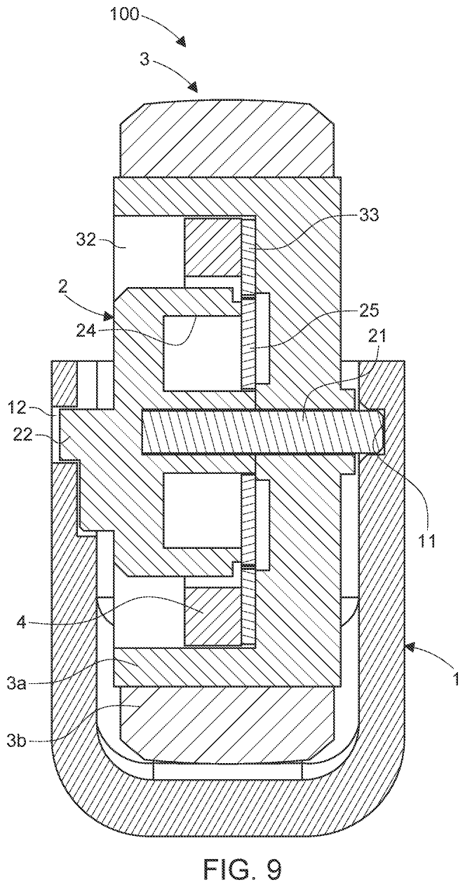

The present application provides a mouse and a magnetic attraction type scroll wheel module thereof. As shown in FIG. 9, the mouse includes the magnetic attraction type scroll wheel module (hereinafter referred to as scroll wheel module) 100 and a housing 900, and the scroll wheel module 100 is disposed on the housing 900.

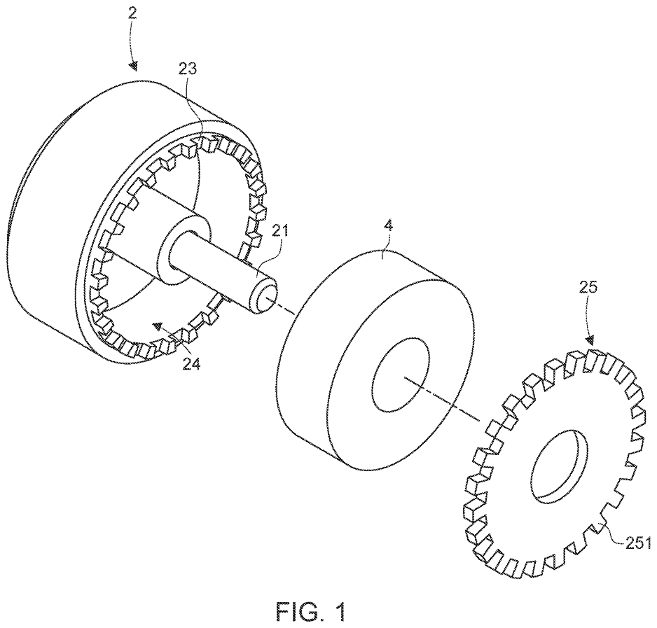

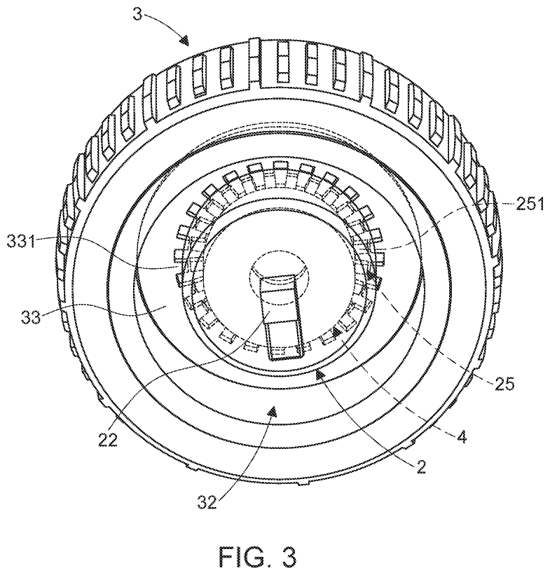

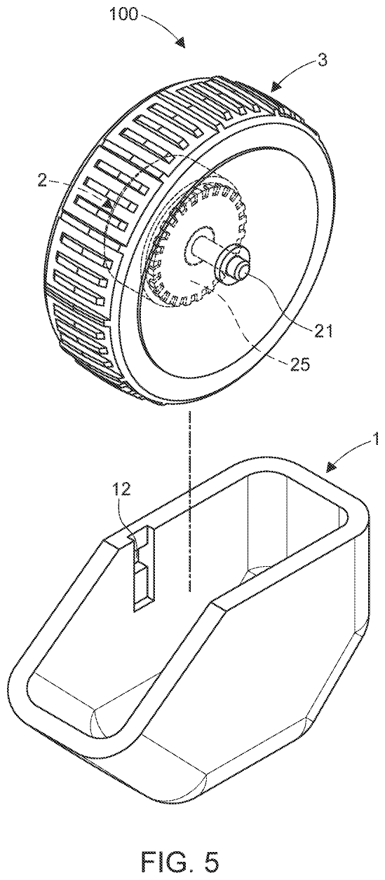

FIGS. 1-7 show a first embodiment of the scroll wheel module 100 of the present application, and the scroll wheel module includes: a frame body 1, an immobile inner wheel 2, a rotating outer wheel 3 and a magnetic object 4.

The frame body 1 is provided with a recess 11 and a clamping recess 12 opposite each other.

The immobile inner wheel 2 is statically mounted on the frame body 1 and is provided with a rotating shaft 21. In one embodiment, the immobile inner wheel is further provided with a clamping block 22, and the rotating shaft 21 and the clamping block 22 are opposite each other. In other words, the protruding rotating shaft 21 and the protruding clamping block 22 are respectively provided on one and the other of two wheel faces of the immobile inner wheel 2. One wheel face of the immobile inner wheel 2 is provided with a cavity 24 and is fixedly provided with an immobile piece 25, and the immobile piece 25 is formed with external teeth 251 projecting radially outwards (from the rotating shaft 21 to the circumference of the immobile inner wheel 2) and arranged in a circle.

The immobile piece 25 can be directly fixedly disposed on the immobile inner wheel 2, and in one embodiment, as shown in FIG. 1, on the above-mentioned wheel face provided with the cavity 24, can be formed with lateral teeth 23 that are arranged in a circle and project in an axial direction (project from one wheel face to the other wheel face) on a lateral side thereof, and the external teeth 251 mesh with the lateral teeth 23.

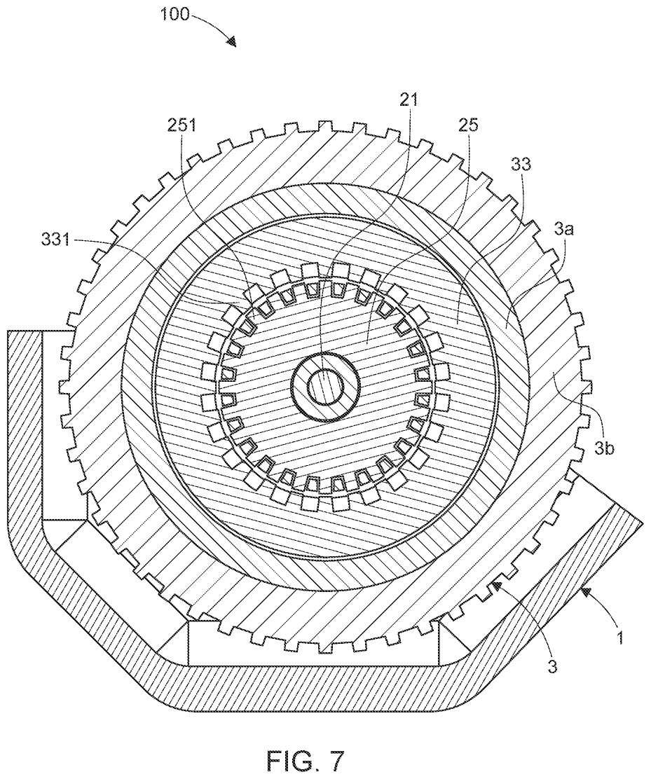

The rotating outer wheel 3 is rotatably sleeved on the rotating shaft 21 and is fixedly provided with a rotating piece 33 (having a hollow portion). In one embodiment, a shaft hole 31 and an accommodating chamber 32 in communication with each other are further respectively provided on one and the other of two wheel faces of the rotating outer wheel 3. The rotating piece 33 is located inside the accommodating chamber 32 and is fixedly disposed on the wheel face provided with the shaft hole 31. The immobile inner wheel 2 is accommodated inside the accommodating chamber 32, and the immobile piece 25 and the rotating piece 33 are directly opposite each other internally and externally. In other words, the immobile piece 25 is coaxially located inside the hollow portion of the rotating piece 33. The rotating piece 33 is formed with internal teeth 331 projecting radially inwards (from the circumference of the rotating outer wheel 3 to the shaft hole 31) and arranged in a circle, and the internal teeth 331 and the external teeth 251 radially correspond to each other in an offset manner (as shown in FIG. 7).

The magnetic object 4 may be a permanent magnet as shown. The magnetic object 4 is directly magnetically attracted to one face of the immobile piece 25 such that the immobile piece 25 is subjected to magnetic conduction by means of the magnetic object 4, and the external teeth 251 of the immobile piece 25 directly magnetically attract the internal teeth 331 of the rotating piece 33. It should be noted that when the immobile inner wheel 2 is fixedly provided with the immobile piece 25, the magnetic object 4 magnetically attracted to the immobile piece 25 will be accommodated in the accommodating chamber 32.

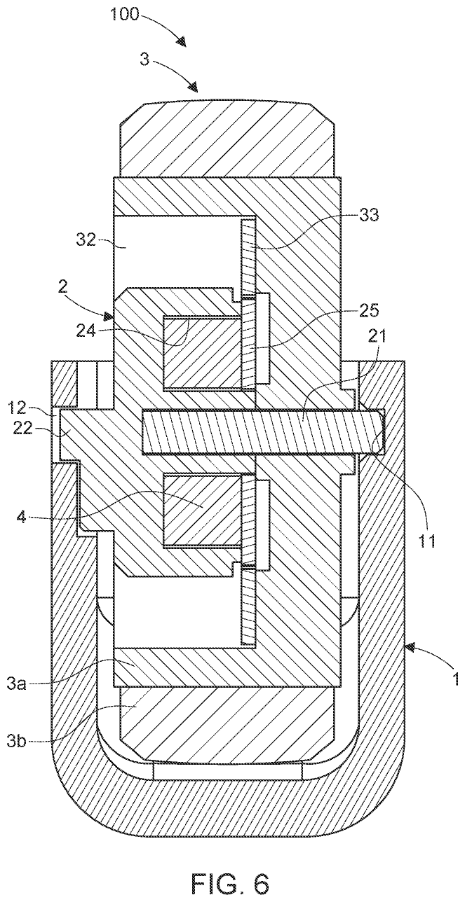

Thus, as shown in FIGS. 6-7, the internal teeth 331 and the external teeth 251 are not separated by any object, and the internal teeth 331 of the rotating piece 33 will be directly magnetically attracted to the external teeth 251 of the immobile piece 25, thereby achieving an improved effect of detent scrolling when a user rolls the rotating outer wheel 3. It should be noted that the distance between the internal teeth 331 and the external teeth 251 can be minimized (as long as the rotating piece 33 can rotate relative to the immobile piece 25, it doesn't matter how small the distance is), thereby further improving the magnetic attraction effect and correspondingly improving the detent scrolling.

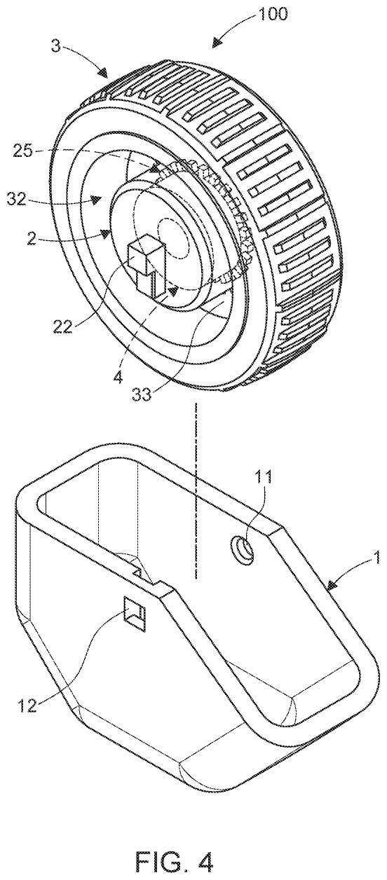

It should also be noted that as shown in FIGS. 4-6, the immobile inner wheel 2 can be statically mounted on the frame body 1 in such a manner that: one end of the rotating shaft 21 passes through the shaft hole 31 first and then is inserted in the recess 11 of the frame body 1, the clamping block 22 is clamped inside the clamping recess 12 of the frame body 1, and because the clamping block 22 and the clamping recess 12 are non-circular and opposite each other, the immobile inner wheel 2 can be statically mounted on the frame body 1 by means of the rotating shaft 21 and the clamping block 22 together.

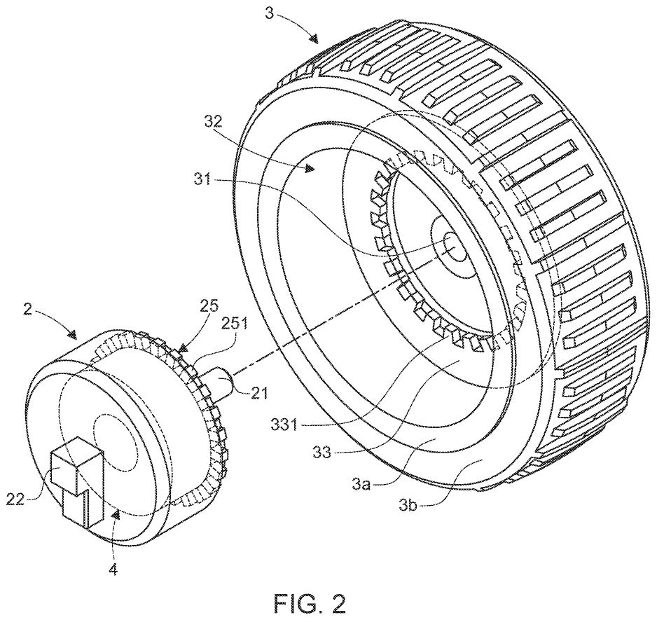

In addition, the circumference of the rotating outer wheel 3 can also be integrally surrounded by a rubber ring 3b. In one embodiment, as shown in FIG. 2, the rotating outer wheel 3 can also be a two-piece structure and include a wheel body 3a and the rubber ring 3b, and the rubber ring 3b surrounds the circumference of the wheel body 3a.

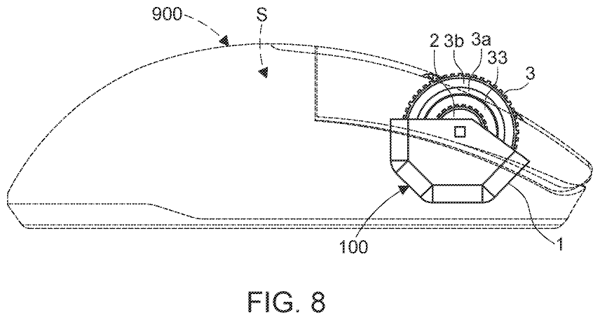

As shown in FIG. 8, the housing 900 is provided with an accommodating space S, the scroll wheel module 100 is accommodated inside the accommodating space S, the rotating outer wheel 3 is partially exposed out of the housing 900, and the frame body 1 is fixed to the housing 900.

FIG. 9 shows a second embodiment of the scroll wheel module 100 of the present application. The second embodiment is generally the same as the first embodiment, and the differences only lie in that the connected object of the magnetic object 4 is changed from the immobile piece 25 to the rotating piece 33, and that the magnetic object 4 is located inside the accommodating chamber 32 and is directly magnetically attracted to one face of the rotating piece 33 such that the hollow magnetic object 4 performs magnetic conduction on the rotating piece 33 and surrounds the outside of the immobile inner wheel 2.

In other embodiments that are not shown, the magnetic object 4 may also be an electromagnet and be electrically connected to the immobile piece 25. Thus, when the user needs to roll the rotating outer wheel 3 quickly, a switch (not shown) electrically connected to the magnetic object 4 can be operated to suspend the magnetic attraction, whereby the rotating outer wheel 3 can be rolled quickly.

In conclusion, the mouse and the magnetic attraction type scroll wheel module thereof in the present application can indeed achieve the expected usage purposes and overcome the defects in the prior art

In addition, the above-mentioned embodiments are only the preferred embodiments given to fully illustrate the present invention, and are not intended to limit the scope of protection of the present invention. Equivalent substitutions or transformations made by a person skilled in the art on the basis of the present invention should fall within the scope of protection of the present invention. The scope of protection of the present invention should be subject to the claims.

What is claimed is:

1. A magnetic attraction type scroll wheel module, comprising:
a frame body;
an immobile inner wheel, statically mounted on the frame body and provided with a rotating shaft, wherein the immobile inner wheel is provided with an immobile piece, and the immobile piece is formed with external teeth projecting outwards and arranged in a circle;
a rotating outer wheel, rotatably sleeved on the rotating shaft and provided with a rotating piece, wherein the rotating piece is formed with internal teeth projecting inwards and arranged in a circle, and the internal teeth and the external teeth correspond to each other in an offset manner; and
a magnetic object, connected to the immobile piece for magnetic conduction, wherein the external teeth of the immobile piece magnetically attract the internal teeth of the rotating piece.

2. The magnetic attraction type scroll wheel module according to claim 1, wherein the immobile inner wheel is provided with a cavity, and the magnetic object is accommodated inside the cavity.

3. The magnetic attraction type scroll wheel module according to claim 1, wherein the immobile inner wheel is formed with lateral teeth projecting from a lateral side thereof, and the external teeth mesh with the lateral teeth.

4. The magnetic attraction type scroll wheel module according to claim 1, wherein the immobile inner wheel is further provided with a clamping block, and the immobile inner wheel is statically mounted on the frame body by means of the rotating shaft and the clamping block together.

5. The magnetic attraction type scroll wheel module according to claim 4, wherein the frame body is provided with a clamping recess, and the clamping block of the immobile inner wheel is clamped inside the clamping recess.

6. The magnetic attraction type scroll wheel module according to claim 4, wherein the rotating outer wheel is provided with an accommodating chamber and a shaft hole in corresponding communication with the accommodating chamber, the immobile inner wheel is accommodated inside the accommodating chamber, and one end of the rotating shaft passes through the shaft hole and is inserted in the frame body.

7. The magnetic attraction type scroll wheel module according to claim 6, wherein the rotating piece is located inside the accommodating chamber and is fixed to the rotating outer wheel.

8. The magnetic attraction type scroll wheel module according to claim 1, wherein the magnetic object is a permanent magnet or an electromagnet.

9. The magnetic attraction type scroll wheel module according to claim 1, wherein the rotating outer wheel is further surrounded by a rubber ring.

10. A magnetic attraction type scroll wheel module, comprising:
a frame body;
an immobile inner wheel, statically mounted on the frame body and provided with a rotating shaft, wherein the immobile inner wheel is provided with an immobile piece, and the immobile piece is formed with external teeth projecting outwards and arranged in a circle;
a rotating outer wheel, rotatably sleeved on the rotating shaft and provided with a rotating piece, wherein the rotating piece is formed with internal teeth projecting inwards and arranged in a circle, and the internal teeth and the external teeth correspond to each other in an offset manner; and
a magnetic object, connected to the rotating piece for magnetic conduction, wherein the internal teeth of the rotating piece magnetically attract the external teeth of the immobile piece.

11. The magnetic attraction type scroll wheel module according to claim 10, wherein the immobile inner wheel is formed with lateral teeth projecting from a lateral side thereof, and the external teeth mesh with the lateral teeth.

12. The magnetic attraction type scroll wheel module according to claim 10, wherein the immobile inner wheel is further provided with a clamping block, and the immobile inner wheel is statically mounted on the frame body by means of the rotating shaft and the clamping block together.

13. The magnetic attraction type scroll wheel module according to claim 12, wherein the frame body is provided with a clamping recess, and the clamping block of the immobile inner wheel is clamped inside the clamping recess.

14. The magnetic attraction type scroll wheel module according to claim 12, wherein the rotating outer wheel is provided with an accommodating chamber and a shaft hole in corresponding communication with the accommodating chamber, the immobile inner wheel is accommodated inside the accommodating chamber, and one end of the rotating shaft passes through the shaft hole and is inserted in the frame body.

15. The magnetic attraction type scroll wheel module according to claim 14, wherein the rotating piece is located inside the accommodating chamber and is fixed to the rotating outer wheel.

16. The magnetic attraction type scroll wheel module according to claim 10, wherein the magnetic object is a permanent magnet or an electromagnet.

17. The magnetic attraction type scroll wheel module according to claim 10, wherein the rotating outer wheel is further surrounded by a rubber ring.

18. A mouse, comprising:
a housing, provided with an accommodating space; and
a magnetic attraction type scroll wheel module accommodated inside the accommodating space, the magnetic attraction type scroll wheel module, comprising:
a frame body;
an immobile inner wheel, statically mounted on the frame body and provided with a rotating shaft, wherein the immobile inner wheel is provided with an immobile piece, and the immobile piece is formed with external teeth projecting outwards and arranged in a circle;
a rotating outer wheel, rotatably sleeved on the rotating shaft and provided with a rotating piece, wherein the rotating piece is formed with internal teeth projecting inwards and arranged in a circle, and the internal teeth and the external teeth correspond to each other in an offset manner; and
a magnetic object, connected to the immobile piece for magnetic conduction, wherein the external teeth of the immobile piece magnetically attract the internal teeth of the rotating piece.

19. A mouse, comprising:
a housing, provided with an accommodating space; and
a magnetic attraction type scroll wheel module accommodated inside the accommodating space, the magnetic attraction type scroll wheel module, comprising:
a frame body;
an immobile inner wheel, statically mounted on the frame body and provided with a rotating shaft, wherein the immobile inner wheel is provided with an immobile piece, and the immobile piece is formed with external teeth projecting outwards and arranged in a circle;
a rotating outer wheel, rotatably sleeved on the rotating shaft and provided with a rotating piece, wherein the rotating piece is formed with internal teeth projecting inwards and arranged in a circle, and the internal teeth and the external teeth correspond to each other in an offset manner; and
a magnetic object, connected to the rotating piece for magnetic conduction, wherein the internal teeth of the rotating piece magnetically attract the external teeth of the immobile piece.
